(19) United States
(12) Patent Application Publication
(10) Pub. No.: US 2014/0376111 A1
(43) Pub. Date: Dec. 25, 2014

(54) WIDE-ANGLE IMAGING LENS ASSEMBLY WITH THREE LENSES

(71) Applicant: Ability Opto-Electronics Technology Co., Ltd., Taichung County (TW)

(72) Inventors: Kuo-yu LIAO, Taichung City (TW); Chao-Hsiang YANG, Taichung City (TW)

(73) Assignee: Ability Opto-Electronics Technology Co., Ltd., Taichung County (TW)

(21) Appl. No.: 14/057,921

(22) Filed: Oct. 18, 2013

(30) Foreign Application Priority Data
Jun. 20, 2013 (TW) 102211511

(51) Int. Cl. G02B 13/00

(52) U.S. Cl. CPC G02B 13/0035
USPC 359/716

(57) ABSTRACT

A wide-angle imaging lens assembly comprises a fixing diaphragm and an optical set including three lenses. An arranging order from an object side to an image side is: a first lens; a second lens; a third lens. Two surfaces of the third lens have at least one inflection point from the optical axis to an end point of the aspheric surfaces. At least one surface of the three lenses are aspheric. The fixing diaphragm is disposed at any position between an object and the second lens. By the concatenation between the lenses and the adapted curvature radius, thickness, interval, refractivity, and Abbe numbers, the assembly attains a big diaphragm with ultra-wide-angle, a shorter height, and a better optical aberration.

The current application claims a foreign priority to the patent application of Taiwan No. 102211511 filed on Jun. 20, 2013.

### BACKGROUND OF THE INVENTION

1. Field of the Invention

The present invention relates to a wide-angle imaging lens assembly with three lenses, in particular to a lens structure attaining a shorter height and a high resolution by curvature, interval and optical parameter between each lens.

2. Description of the Related Art

The conventional lens structure adopts an image display lens assembly which is applied to smart phone, tablet PC, cell phone, notebook, and webcam. The electronic products are developed to become lighter, thinner, shorter, and smaller and provide with higher efficiency. A video sensor of the image display lens assembly, such as Charge Coupled Device (CCD) or Complementary Metal Oxide Semiconductor (CMOS), is also developed for a higher pixel, so the lens structure is ceaselessly developed to be provided with compactness and higher resolution.

Therefore, the present invention is disclosed in accordance with a lens structure with multi-lens for a demand of the development of the image display lens assembly, especially to an imaging lens assembly of a lens structure with at least three lenses.

### SUMMARY OF THE INVENTION

In view of the conventional lens structure that has big volume and lack of efficiency, a wide-angle imaging lens assembly with three lenses is disclosed.

It is an object of the present invention to provide a wide-angle imaging lens assembly with three lenses, which comprises a fixing diaphragm and an optical set. The optical set includes a first lens, a second lens, and a third lens, an arranging order thereof from an object side to an image side is: the first lens with a positive refractive power defined near an optical axis and two surfaces thereof defined as convex surfaces disposed near the optical axis, and at least one surface of the first lens is aspheric; the second lens having a lens with a negative refractive power defined near the optical axis and a concave surface directed toward the object side, and at least one surface of the second lens is aspheric; the third lens having a lens with a positive refractive power defined near the optical axis and a convex surface directed toward the object side, and at least one surface of the third lens is aspheric and have at least one inflection point from the optical axis to an end point of the aspheric surfaces; and the diaphragm disposed at any position between an object and the second lens.

The imaging lens assembly satisfies the following conditional expression: 0.5<f/TL<0.8. The TL is defined as a distance from a top point of the object side surface of the first lens to an imaging surface side. The f is defined as a focal length of the entire lens assembly.

The imaging lens assembly satisfies the following conditional expression: 0.8<TL/Dg<1.2. The TL is defined as the distance from a top point of the object side surface of the first lens to the imaging surface side. The Dg is defined as a length diagonal of a maximum using visual angle imaged on said imaging surface.

A shape of the aspheric surface satisfies a formula of:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + {Gh}^{16} + {Hh}^{18} + {Jh}^{20} + …$$

The z is defined as a position value about a location at a height of h along a direction of the optical axis referring to a surface top point. The k is defined as a conic constant. The c is a reciprocal of a radius of a curvature. The A, B, C, D, E, etc. are defined as high-order aspheric surface coefficients.

The present invention is characterized in that a lens structure attains a big diaphragm with ultra-wide-angle, a shorter height, and a high resolution by curvature, interval, and optical parameter between each lens.

### BRIEF DESCRIPTION OF THE DRAWINGS

FIG. 1 is a schematic view showing an optical structure of a first preferred embodiment of the present invention;

FIG. 2 is a schematic view showing an astigmatic aberration of the first preferred embodiment of the present invention;

FIG. 3 is a schematic view showing a distorted aberration of the first preferred embodiment of the present invention;

FIG. 4 is a schematic view showing a spherical aberration of the first preferred embodiment of the present invention;

FIG. 5 is a schematic view showing an optical structure of a second preferred embodiment of the present invention;

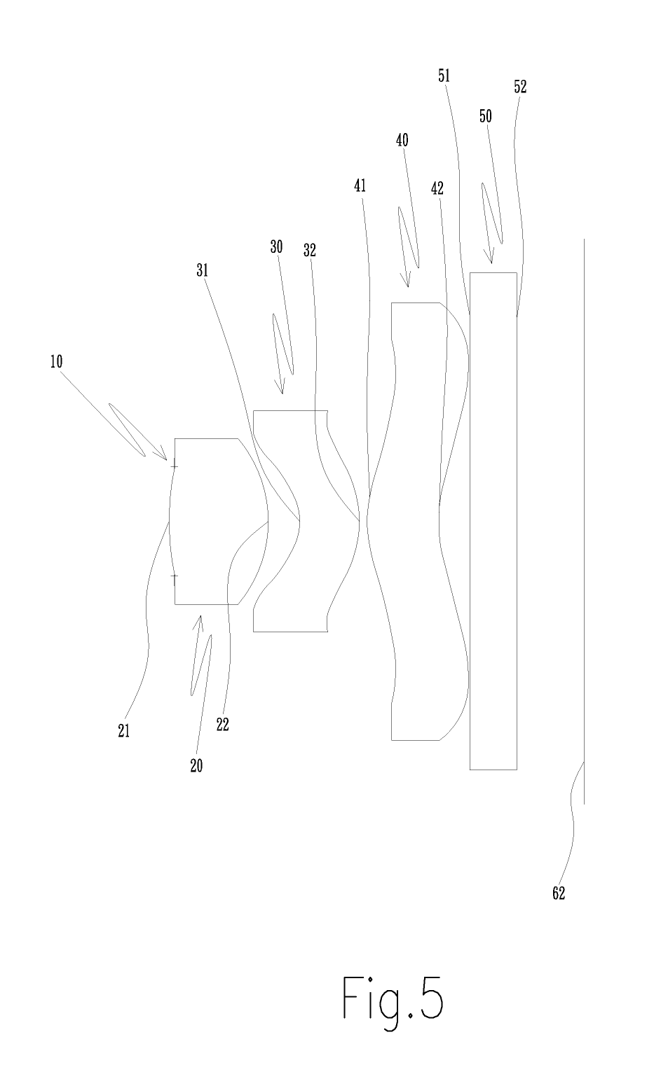

FIG. 6 is a schematic view showing an astigmatic aberration of the second preferred embodiment of the present invention;

FIG. 7 is a schematic view showing a distorted aberration of the second preferred embodiment of the present invention;

FIG. 8 is a schematic view showing a spherical aberration of the second preferred embodiment of the present invention;

FIG. 9 is a schematic view showing an optical structure of a third preferred embodiment of the present invention;

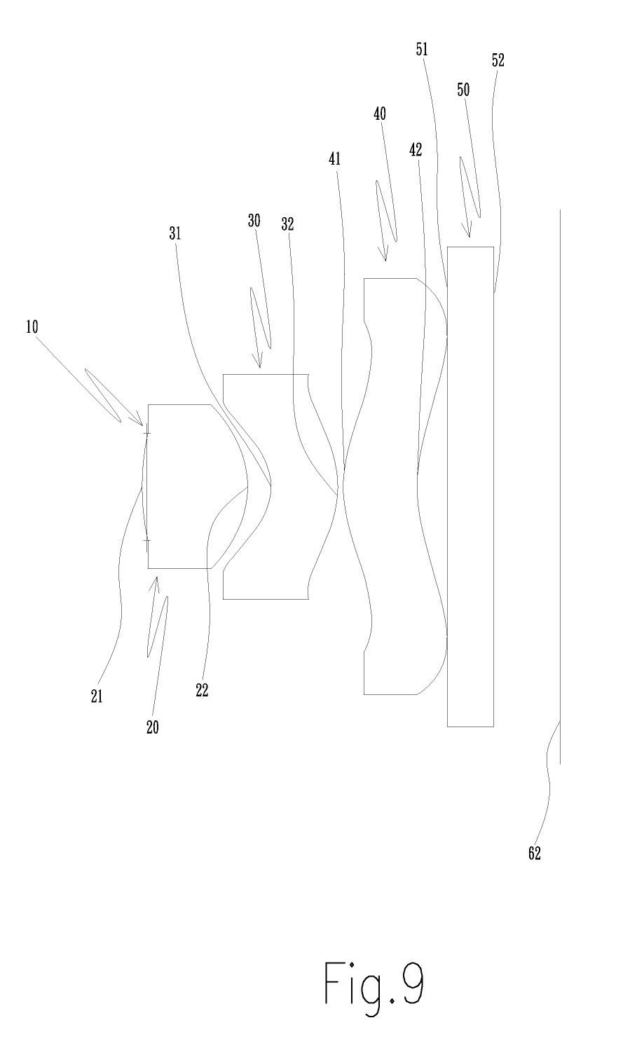

FIG. 10 is a schematic view showing an astigmatic aberration of the third preferred embodiment of the present invention;

FIG. 11 is a schematic view showing a distorted aberration of the third preferred embodiment of the present invention; and

FIG. 12 is a schematic view showing a spherical aberration of the third preferred embodiment of the present invention.

### DETAILED DESCRIPTION OF THE PREFERRED EMBODIMENTS

Before describing in detail, it should note that the like elements are denoted by the similar reference numerals throughout disclosure.

The present invention provides an imaging lens structure, in particular to a lens structure attaining a big diaphragm with ultra-wide-angle, a shorter height, and a high resolution by a curvature, an interval, and an optical parameter between each lens.

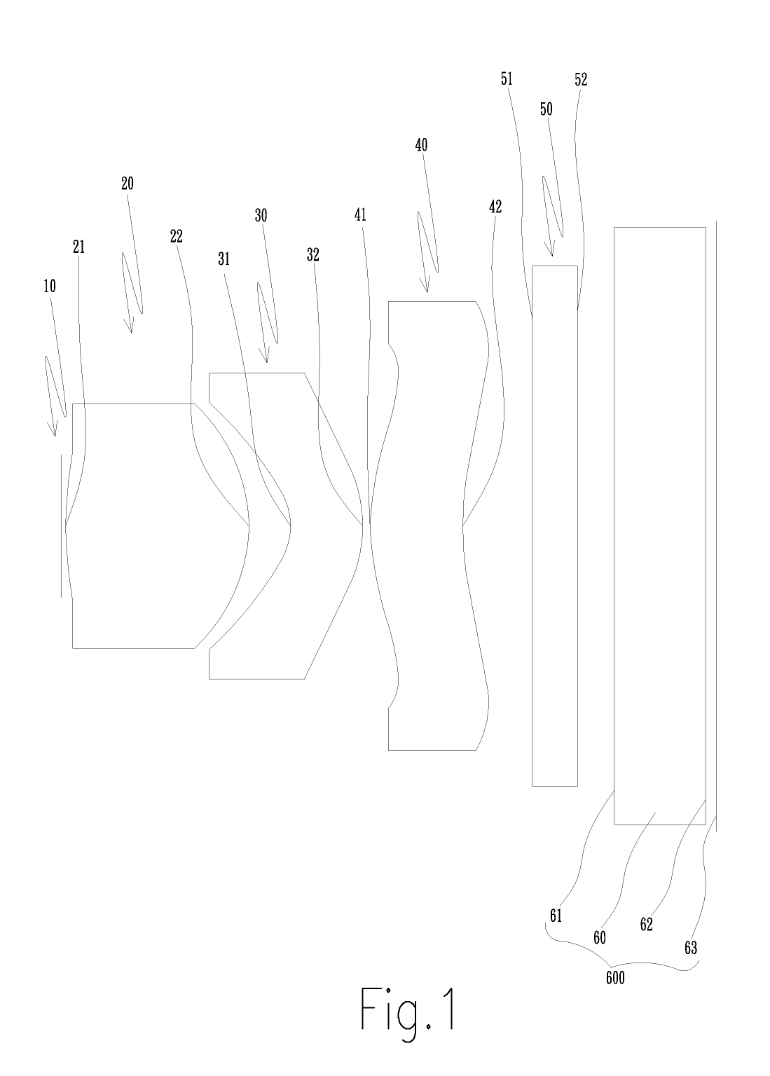

Referring to FIG. 1, a schematic view of an optical structure of a wide-angle imaging lens assembly with three lenses is shown. The structure of the imaging lens comprises a fixing diaphragm 10 and an optical set. The optical set includes a first lens 20, a second lens 30, and a third lens 40, an arranging order thereof from an object side to an image side is: the first lens 20 with a positive refractive power defined near an optical axis and two surfaces thereof defined as convex surfaces disposed near an optical axis; the second lens 30 with a negative refractive power defined near an optical axis and a concave surface directed toward the object side; the third lens 40 with a positive refractive power defined near an optical axis and a convex surface directed toward the object side, two surfaces of the third lens 40 have at least one inflection point from the optical axis to an end point of the aspheric surfaces, and at least one surface of the first lens 20, the second lens 30, and the third lens 40 is aspheric; the fixing diaphragm 10 disposed at any position between an object and the second lens 30; a filter unit 50 filtering light with specific wave length and being adopted by an infrared stopping filter unit applied to a visible light image; and an image sensor 60 (an imaging surface side) used for receiving a digital signal transformed by an infrared invisible light image of the filter unit. The image sensor 60 includes a flat protection lens 61 and a video sensor 62. The video sensor 62 is preferably adopted by Charge Coupled Device (CCD) or Complementary Metal Oxide Semiconductor (CMOS).

The imaging lens assembly satisfies the following conditional expression: 0.5<f/TL<0.8. The TL is defined as a distance from a top point of the object side surface of the first lens to the imaging surface side. The f is defined as a focal length of the entire lens assembly.

The imaging lens assembly satisfies the following conditional expression: 0.8<TL/Dg<1.2. The TL is defined as the distance from a top point of the object side surface of the first lens to the imaging surface side. The Dg is defined as a length diagonal of a maximum using visual angle imaged on said imaging surface.

The first lens 20 includes a first surface 21 facing an object side and a second surface 22 facing the imaging surface side. The first surface 21 is defined as a convex surface disposed near the optical axis opposite to the object side. The second surface 22 is defined as a convex surface disposed near the optical axis opposite to the imaging surface side. The second lens 30 includes a third surface 31 facing the object side and a fourth surface 32 facing the imaging surface side. The third surface 31 is defined as a concave surface disposed near the optical axis opposite to the object side. The fourth surface 32 is defined as a convex surface disposed near the optical axis opposite to the imaging surface side. The third lens 40 includes a fifth surface 41 facing the object side and a sixth surface 42 facing the imaging surface side. The fifth surface 41 is defined as a convex surface disposed near the optical axis opposite to the object side. The sixth surface 42 is defined as a concave surface disposed near the optical axis opposite to the imaging surface side. At least one surface of the first lens 20, the second lens 30, and the third lens 40 is aspheric, thereby correcting the spherical aberration and the image aberration for having a characteristic of low tolerance sensitivity.

A shape of the aspheric surface of the imaging lens assembly satisfies a formula of:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + {Gh}^{16} + {Hh}^{18} + {Jh}^{20} + …$$

The z is defined as a position value about a location at a height of h along a direction of the optical axis referring to a surface top point. The k is defined as a conic constant. The c is a reciprocal of a radius of a curvature. The A, B, C, D, E, etc. are defined as high-order aspheric surface coefficients.

In an ultra-wide-angle micro-optical image capturing device of the present invention, the fixing diaphragm 10 is disposed at any point between the object and the second lens 30 for getting an incident beam. The first lens 20 and the third lens 40 are adopted by lenses with positive refractive power defined near the optical axis, and the second lens 30 is adopted by lenses with negative refractive power defined near the optical axis. The first lens 20 defined near the optical axis adopts the first surface 21 convexly defined toward the object side for assembling the external incident beam with ultra-wide-angle so as to keep the beam on the fourth surface 32 of the second lens 30, thereby presenting a function of the aspheric surface, correcting the aberration, reducing the tolerance sensitivity, and rendering the device have ultra-wide-angle with an image-capture angle over 70°. The fifth surface 41 defined on the third lens 40 as a concave surface disposed near the optical axis opposite to the object side is then expanded and radiated, so that the beam is able to be spread on the sixth surface 42 of the third lens 40 with a larger dimension. That is to say, the incident beam is expanded and radiated by the fifth surface 41 so as to be spread on the sixth surface 42 with a larger dimension, thereby presenting the function of aspheric surface, correcting the aberration, and reducing tolerance sensitivity.

The aspheric surface not only corrects the spherical aberration and the image aberration but also reduces the full length of the lens optical system. The first lens 20, the second lens 30, and the third lens 40 are preferably adopted by plastic, which is conducive to eliminate the aberration and reduce the weight of the lens. The entire optical system consists of three plastic lenses and benefits a mass production. The optical system also provides with the low tolerance sensitivity to meet a requirement of the mass production. The filter unit 50 used for filtering infrared invisible light and allowing visible light forms an ultra-wide-angle micro-optical image capturing device capable of capturing the sight that people see.

By the concatenation between the above-mentioned surfaces of lenses and the adapted curvature radius, thickness, interval, refractivity, and Abbe numbers, the assembly attains a big diaphragm with ultra-wide-angle, a shorter height, and a better optical aberration.

### First Preferred Embodiment Of The Present Invention

Due to the above-mentioned technique of the present invention, it is able to be practiced in accordance with the following values:

Basic lens data of the first preferred embodiment

| | | Curvature | Thickness/ | Refrac- | Abbe |
|---|---|---|---|---|---|
| | | radius | Interval | tivity | number |
| Surfaces | | (Radius) | (Thickness) | (Nd) | (Vd) |
| Fixing diaphragm 10 | | ∞ | 0.02 | | |
| First | First | 1.60 | 0.80 | 1.531 | 56.04 |
| lens 20 | surface 21 | | | | |
| | Second | −0.67 | 0.18 | | |
| | surface 22 | | | | |
| Second | Third | −0.27 | 0.31 | 1.632 | 23.42 |
| lens 30 | surface 31 | | | | |
| | Fourth | −0.54 | 0.04 | | |
| | surface 32 | | | | |
| Third | Fifth | 0.95 | 0.40 | 1.535 | 56.07 |
| lens 40 | surface 41 | | | | |
| | Sixth | 1.45 | 0.30 | | |
| | surface 42 | | | | |
| Filter | Seventh | ∞ | 0.20 | 1.516800 | 64.167336 |
| unit 50 | surface 51 | | | | |
| | Eighth | ∞ | 0.16 | | |
| | surface 52 | | | | |
| Flat | Ninth | ∞ | 0.40 | 1.516800 | 64.167336 |
| protection | surface 61 | | | | |
| lens 60 | Tenth | ∞ | 0.04 | | |
| | surface 62 | | | | |

The filter unit 50 has a thickness of 0.20 mm and is adopted by an infrared stopping filter unit. A wave length of the light passing therethrough is 450˜650 mm. A thickness of the flat protection lens 51 is 0.4 mm.

The A, B, C, D, E, F, and G are defined as high-order aspheric surface coefficients.

The values of quadratic surface coefficient of the aspheric surface of the first preferred embodiment are listed as follows:

The first surface 21 (k=−57.43):

A: 1.365876

B: −8.6805204

C: −9.8059036

D: 368.48551

E: −1190.726

F: 0

G: 0

The second surface 22 (k=−0.43):

A: −0.6585751

B: 4.380543

C: −9.3806803

D: −11.568506

E: 49.074082

F: 0

G: 0

The third surface 31 (k=−0.85):

A: 2.9706069

B: 7.0842414

C: −43.889741

D: 104.62352

E: −68.080409

F: 0

G:0

The fourth surface 32 (k=−0.52):

A: 1.0538312

B: 1.7699267

C: −3.6499397

D: 1.355012

E: 5.4709283

F: 0

G: 0

The fifth surface 41 (k=0):

A: −0.75829942

B: 0.06547559

C: 0.31834606

D: −1.1569042

E: 0

F: 0

G: 0

The sixth surface 42 (k=0):

A: −0.31799708

B: 0.13991659

C: −0.28780822

D: 0.1039187

E: 0

F: 0

G: 0

According to the above-mentioned values, the related exponent of performance of the micro-image capturing lens is: f=1.73 mm; TL=2.85 mm; f/TL=0.61; Dg=2.64 mm; TL/Dg=1.08.

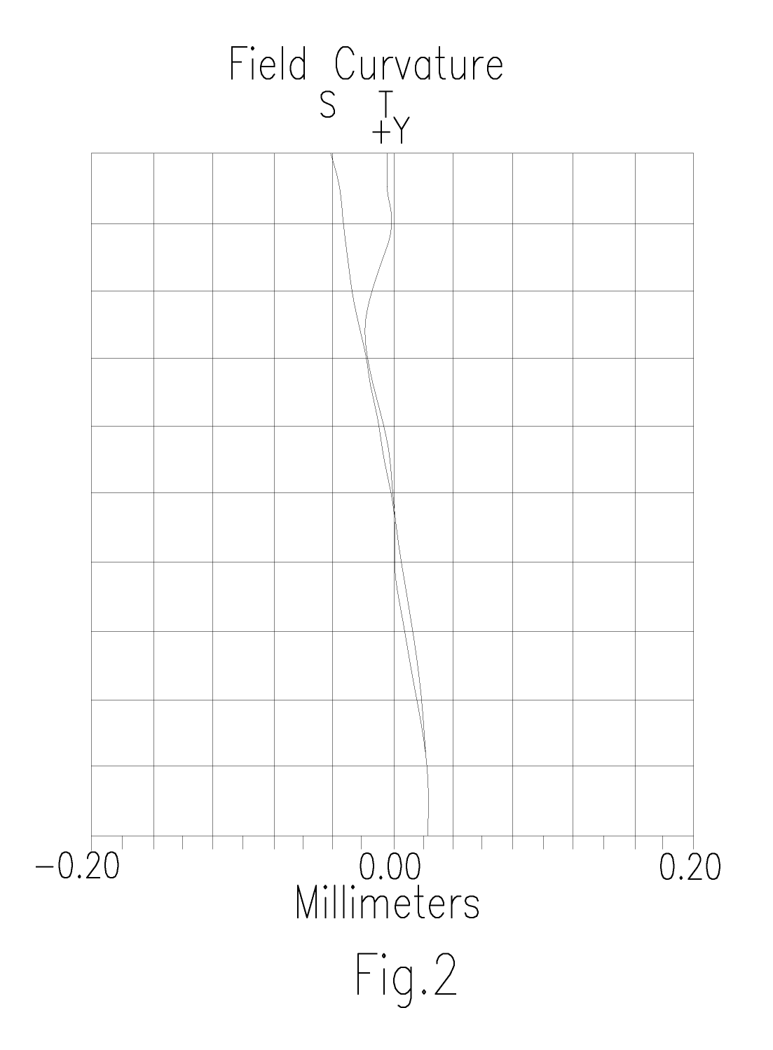

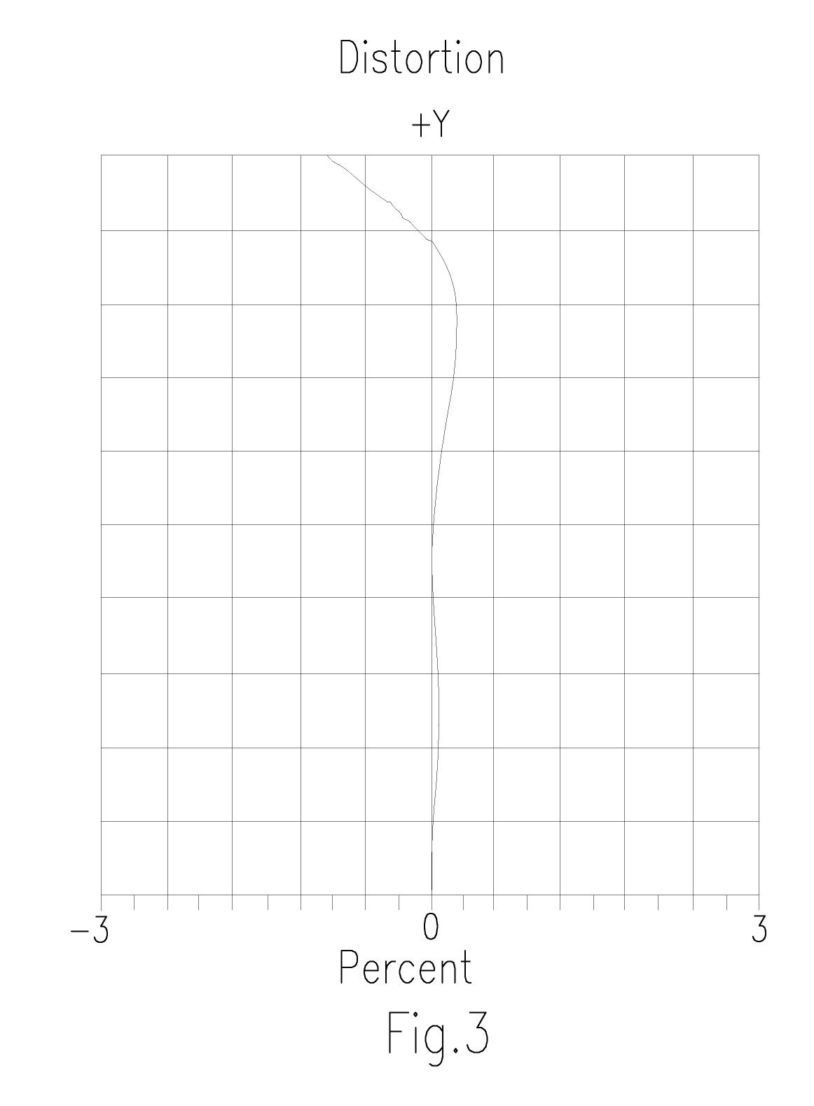

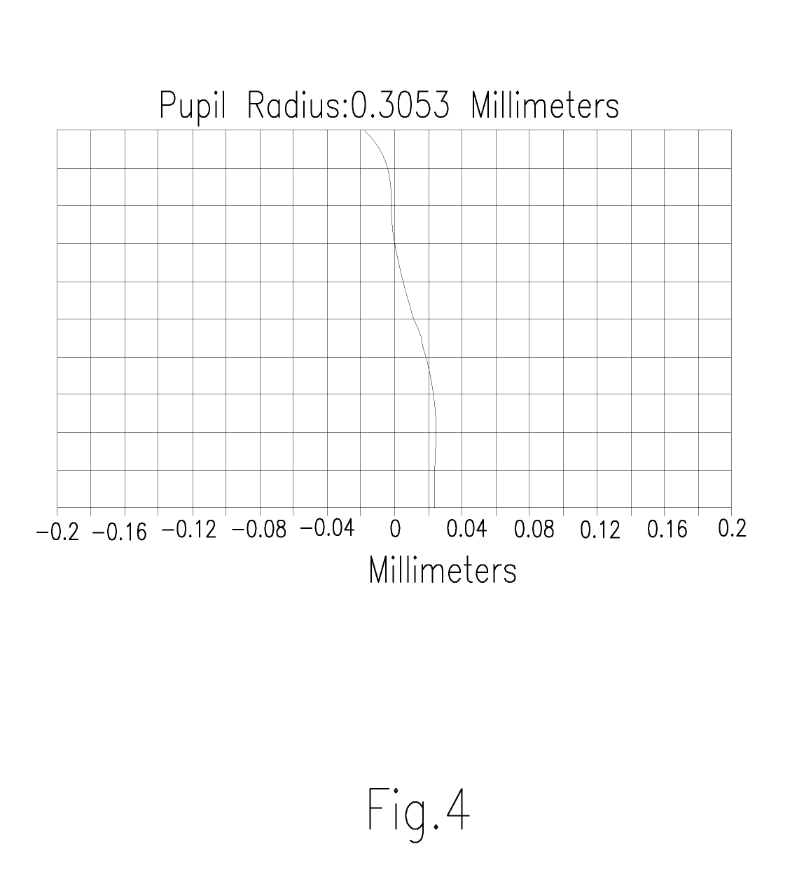

Referring to FIG. 2, a schematic view of an astigmatic aberration of the first preferred embodiment of the present invention is shown. Referring to FIG. 3, a schematic view of a distorted aberration of the first preferred embodiment of the present invention is shown. Referring to FIG. 4, a schematic view of a spherical aberration of the first preferred embodiment of the present invention is shown. The measured astigmatic aberration, distorted aberration, and spherical aberration are in the standard scope and have a good optical performance and imaging quality according to the above-mentioned figures.

### Second Preferred Embodiment Of The Present Invention

Due to the above-mentioned technique of the present invention, it is able to be practiced in accordance with the following values:

Basic lens data of the second preferred embodiment

| | | Curvature | Thickness/ | Refrac- | Abbe |
|---|---|---|---|---|---|
| | | radius | Interval | tivity | number |
| Surfaces | | (Radius) | (Thickness) | (Nd) | (Vd) |
| Fixing diaphragm 10 | | ∞ | −0.02 | | |
| First | First | 1.05 | 0.44 | 1.535 | 56.07 |
| lens 20 | surface 21 | | | | |
| | Second | −0.65 | 0.14 | | |
| | surface 22 | | | | |
| Second | Third | −0.25 | 0.27 | 1.636 | 23.89 |
| lens 30 | surface 31 | | | | |
| | Fourth | −0.50 | 0.03 | | |
| | surface 32 | | | | |
| Third | Fifth | 0.52 | 0.32 | 1.535 | 56.07 |
| lens 40 | surface 41 | | | | |
| | Sixth | 0.71 | 0.14 | | |
| | surface 42 | | | | |
| Filter | Seventh | ∞ | 0.21 | 1.517 | 64.17 |
| unit 50 | surface 51 | | | | |
| | Eighth | ∞ | 0.30 | | |
| | surface 52 | | | | |

The filter unit 50 has a thickness of 0.21 mm and is adopted by an infrared stopping filter unit. A wave length of the light passing therethrough is 450˜650 mm.

The A, B, C, D, E, F and G are defined as high-order aspheric surface coefficients.

The values of quadratic surface coefficient of the aspheric surface of the second preferred embodiment are listed as follows:

The first surface 21 (k=6.09):

A: −1.1023157

B: −26.189183

C: 116.22088

D: 18789.108

E: −609386.81

F: 6539635.9

G: −21384643

The second surface 22 (k=1.18):

A: −0.32698743

B: −53.150618

C: 964.4416

D: −9165.1251

E: 76689.64

F: −482917.26

G: 1388042.9

The third surface 31 (k=−2.81):

A: −7.6082839

B: −43.852814

C: 1907.5017

D: −11025.063

E: −27513.172

F: 441632.72

G: −1081830.3

The fourth surface 32 (k=−0.17):

A: −0.56514905

B: 10.312056

C: 46.350081

D: 126.24074

E: −1812.7873

F: 3592.9441

G: 289.53629

The fifth surface 41 (k=−8.09):

A: −0.076539235

B: −2.6656011

C: 14.371477

D: −40.391019

E: 61.092792

F: −47.329039

G: 14.860091

The sixth surface 42(k=−0.84):

A: −1.7998032

B: 3.7990291

C: −7.7749348

D: 12.048202

E: −13.308803

F: 8.6620901

G: −2.4369348

According to the above-mentioned values, the related exponent of performance of the micro-image capturing lens is: f=1.16 mm; TL=1.85 mm; f/TL=0.63; Dg=2.19 mm; TL/Dg=0.85.

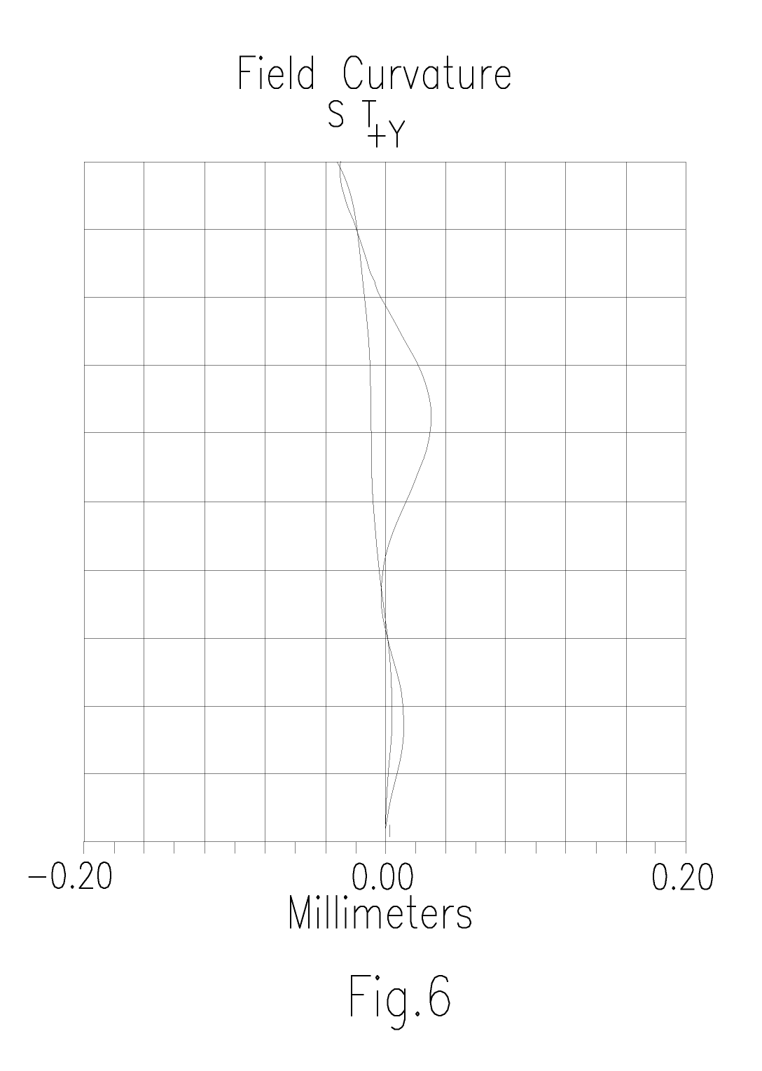

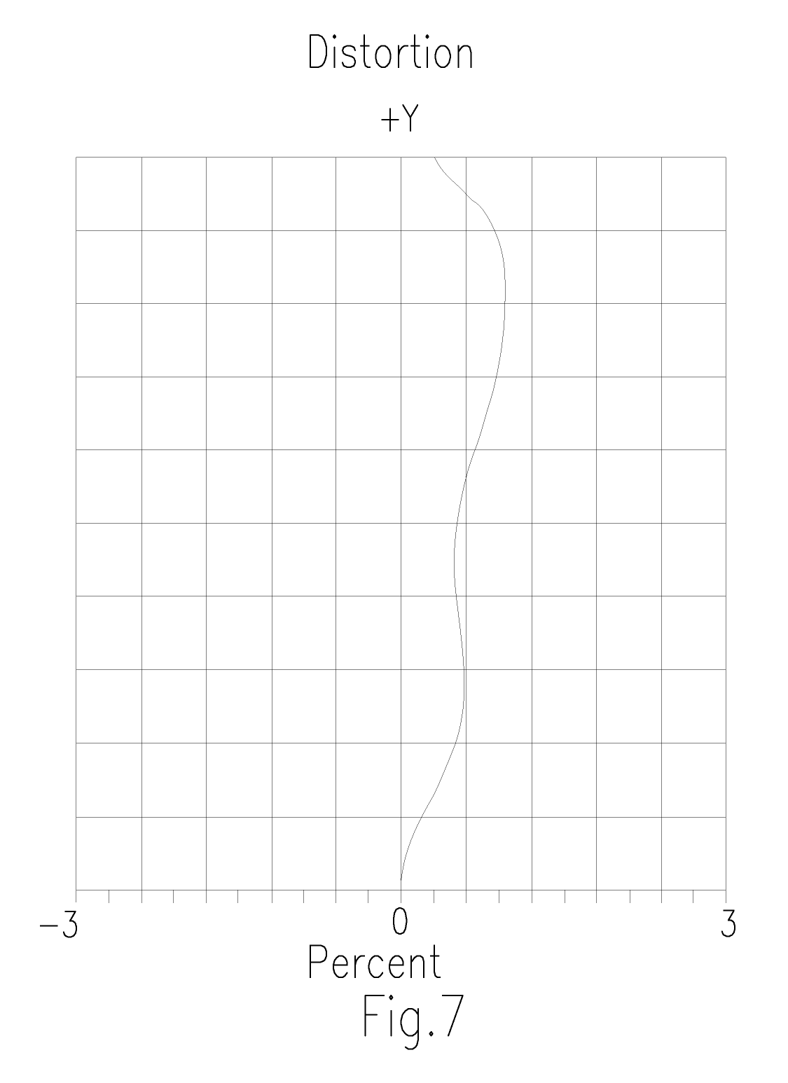

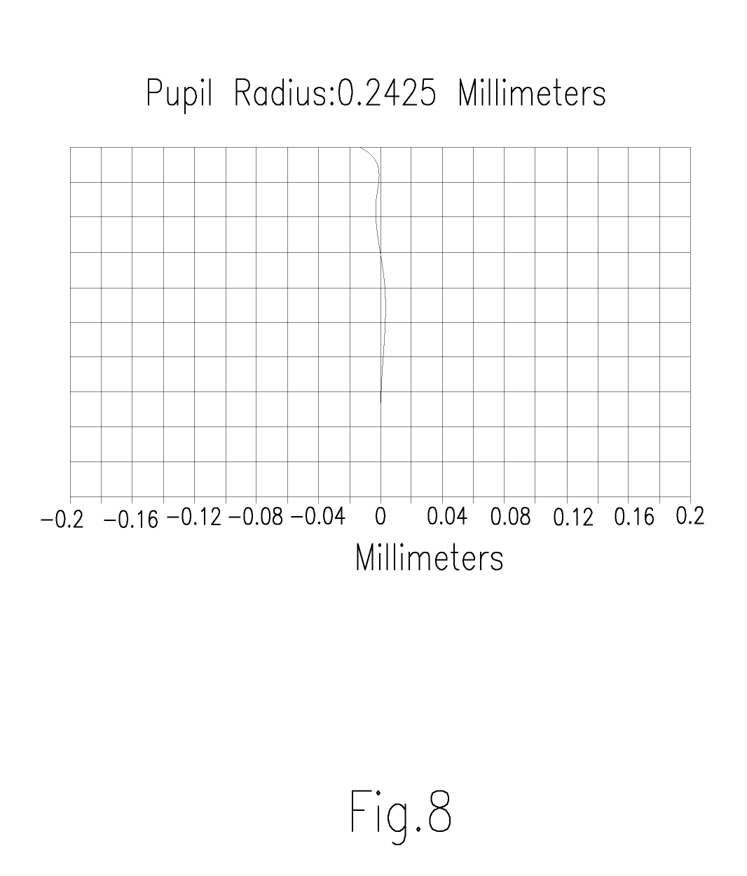

Referring to FIG. 6, a schematic view of an astigmatic aberration of the second preferred embodiment of the present invention is shown. Referring to FIG. 7, a schematic view of a distorted aberration of the second preferred embodiment of the present invention is shown. Referring to FIG. 8, a schematic view of a spherical aberration of the second preferred embodiment of the present invention is shown. The measured astigmatic aberration, distorted aberration, and spherical aberration are in the standard scope and have a good optical performance and imaging quality according to the above-mentioned figures.

### Third Preferred Embodiment of the Present Invention

Due to the above-mentioned technique of the present invention, it is able to be practiced in accordance with the following values:

Basic lens data of the third preferred embodiment

| | | Curvature | Thickness/ | Refrac- | Abbe |
|---|---|---|---|---|---|
| | | radius | Interval | tivity | number |
| Surfaces | | (Radius) | (Thickness) | (Nd) | (Vd) |
| Fixing diaphragm 10 | | ∞ | −0.02 | | |
| First | First | 1.04 | 0.48 | 1.535 | 56.07 |
| lens 20 | surface 21 | | | | |
| | Second | −0.49 | 0.11 | | |
| | surface 22 | | | | |
| Second | Third | −0.23 | 0.30 | 1.636 | 23.89 |
| lens 30 | surface 31 | | | | |
| | Fourth | −0.52 | 0.03 | | |
| | surface 32 | | | | |
| Third | Fifth | 0.57 | 0.34 | 1.535 | 56.07 |
| lens 40 | surface 41 | | | | |
| | Sixth | 0.78 | 0.14 | | |
| | surface 42 | | | | |
| Filter | Seventh | ∞ | 0.21 | 1.517 | 64.17 |
| unit 50 | surface 51 | | | | |
| | Eighth | ∞ | 0.30 | | |
| | surface 52 | | | | |

The filter unit 50 has a thickness of 0.21 mm and is adopted by an infrared stopping filter unit. A wave length of the light passing therethrough is 450˜650 mm.

The A, B, C, D, E, F and G are defined as high-order aspheric surface coefficients.

The values of quadratic surface coefficient of the aspheric surface of the third preferred embodiment are listed as follows:

The first surface 21 (k=6.31):

A: −1.3367754

B: −13.987632

C: −54.392765

D: 17861.559

E: −593813.32

F: 6811183

G: −24006065

The second surface 22 (k=0.34):

A: 1.203641

B: −41.208674

C: 870.55727

D: −9964.2512

E: 81911.52

F: −464660.88

G: 1335218.1

The third surface 31 (k=−1.52):

A: 2.6914271

B: −93.723988

C: 1563.6366

D: −9295.1503

E: −13608.054

F: 361441.01

G: −1002774.6

The fourth surface 32 (k=−0.31):

A: 1.0435358

B: 7.1079736

C: −7.5063774

D: 158.73163

E: −1252.1369

F: 3801.4095

G: −3878.1452

The fifth surface 41 (k=−6.01):

A: −0.13206196

B: −2.0653622

C: 11.786095

D: −39.04656

E: 64.651646

F: −53.048297

G: 18.098259

The sixth surface 42 (k=−0.42):

A: −1.5218582

B: 3.077598

C: −7.2123223

D: 11.201159

E: −12.923432

F: 9.4710251

G: −3.253487

According to the above-mentioned values, the related exponent of performance of the micro-image capturing lens is: f=1.16 mm; TL=1.90 mm; f/TL=0.61; Dg=2.19 mm; TL/Dg=0.87.

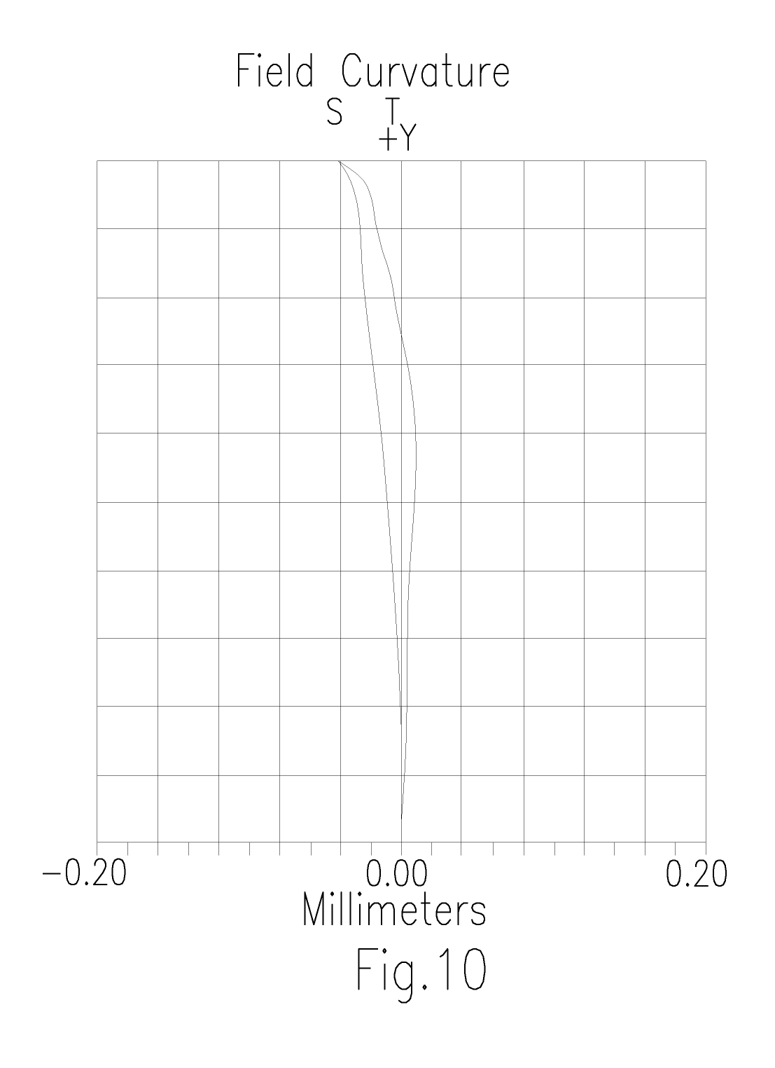

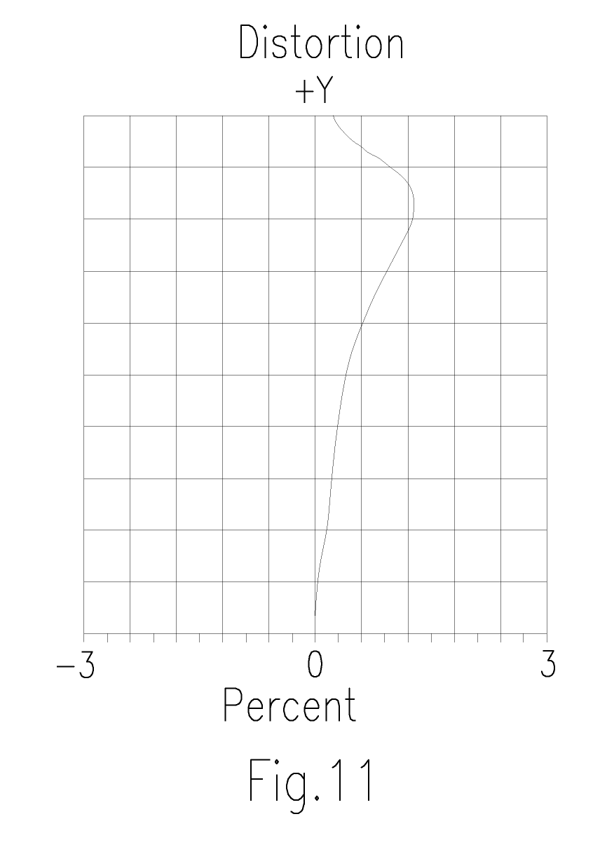

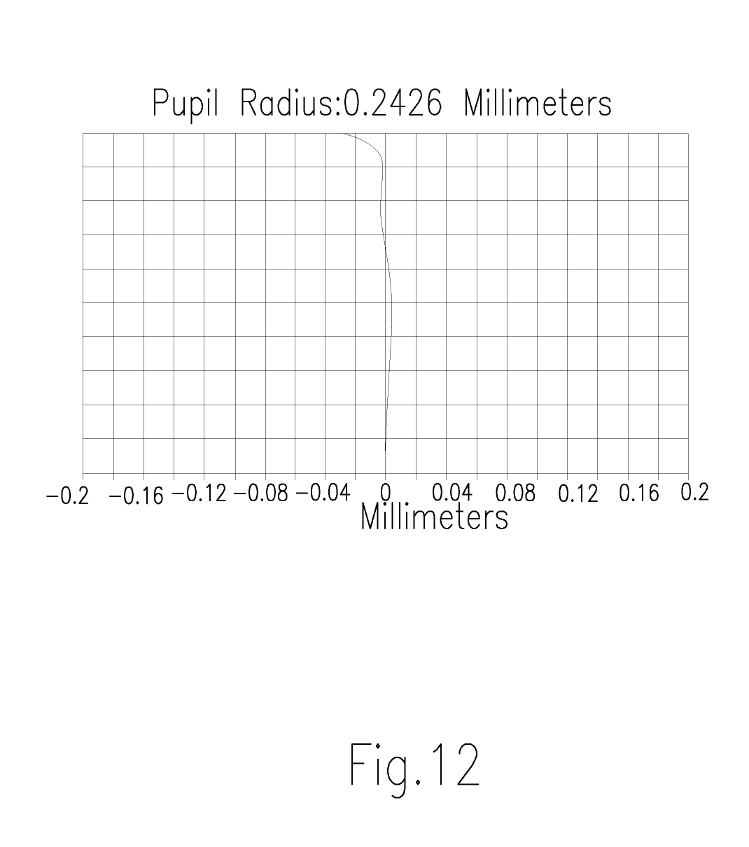

Referring to FIG. 10, a schematic view of an astigmatic aberration of the third preferred embodiment of the present invention is shown. Referring to FIG. 11, a schematic view of a distorted aberration of the third preferred embodiment of the present invention is shown. Referring to FIG. 12, a schematic view of a spherical aberration of the third preferred embodiment of the present invention is shown. The measured astigmatic aberration, distorted aberration, the spherical aberration are in the standard scope and have a good optical performance and imaging quality according to the above-mentioned figures.

The micro-optical image capturing device utilizes three aspheric lenses and the filter unit 50 which filters a light with infrared wave length and allows the visible light with the required wave length. The filter unit 50 is preferably adopted by an infrared stopping filter unit applied to the visible light image.

By making use of the aspheric surface that corrects the aberration and reduces the tolerance sensitivity, not only the aberration is corrected but also the full length of the lens optical system is reduced. Further, the device provides with a ultra-wide-angle with an image capturing angle over 70°. The first, second, and third lenses are preferably adopted by plastic, which is conducive to eliminate the aberration and reduce the weight of the lens. The optical system consists of two plastic lenses and provides with the low tolerance sensitivity. The optical system is also easy to be manufactured and assembled and benefits a mass production. Furthermore, the optical system provides with a fine imaging quality to meet the requirement of miniaturizing the portable image capturing products.

While we have shown and described the embodiment in accordance with the present invention, it should be clear to those skilled in the art that further embodiments may be made without departing from the scope of the present invention.

I claim:

1. A wide-angle imaging lens assembly with three lenses comprising a fixing diaphragm and an optical set; said optical set including a first lens, a second lens, and a third lens, an arranging order thereof from an object side to an image side being:
said first lens having a positive refractive power defined near an optical axis and two surfaces of said first lens defined as convex surfaces disposed near the optical axis; at least one surface being aspheric;
said second lens having a lens with a negative refractive power defined near the optical axis and a concave surface directed toward said object side; at least one surface of said second lens being aspheric;
said third lens having a lens with a positive refractive power defined near the optical axis and a convex surface directed toward said object side; at least one surface of said third lens being aspheric; said two surfaces having at least one inflection point from said optical axis to an end point of said aspheric surfaces; and
said diaphragm disposed at any position between an object and said second lens.

2. The wide-angle imaging lens assembly with three lenses as claimed in claim 1 further satisfying the following conditional expression: 0.5<f/TL<0.8, wherein said TL is defined as a distance from a top point of the object side surface of said first lens to an imaging surface side, said f is defined as a focal length of said entire lens assembly.

3. The wide-angle imaging lens assembly with three lenses as claimed in claim 1 further satisfying the following conditional expression: 0.8<TL/Dg<1.2, wherein said TL is defined as said distance from a top point of the said object side surface of said first lens to said imaging surface side, and said Dg is defined as a length diagonal of a maximum using visual angle imaged on said imaging surface.
